(19) United States
(12) Patent Application Publication
(10) Pub. No.: US 2013/0309396 A1
(43) Pub. Date: Nov. 21, 2013

(54) Thermoplastic/Fiber Composite-Based Electrically Conductive Structures

(71) Applicant: United States of America as Represented by the Secretary of the Air Force, Rome, NY (US)

(72) Inventor: David J. Legare, Ava, NY (US)

(21) Appl. No.: 13/954,079

(22) Filed: Jul. 30, 2013

Related U.S. Application Data
(63) Continuation-in-part of application No. 12/932,341, filed on Feb. 23, 2011.

(51) Int. Cl. H01B 13/22

(52) U.S. Cl. CPC H01B 13/22
USPC 427/121; 264/104

(57) ABSTRACT

A low-cost method for thermoplastic injection molding of thermoplastic/fiber composite structures which are imparted with the desired properties of electrical conductivity, radio frequency (RF) energy reflectivity, and electromagnetic interference (EMI) shielding, while also possessing the basic physical and structural properties of the same part produced by traditional resin/fiber composite means such as expoxy/carbon fiber lay-up or infusion.

### REFERENCE TO PRIOR APPLICATIONS UNDER 35 U.S.C. §120

This patent application is a Continuation-In-Part of and claims the priority benefit of pending non-provisional application Ser. No. 12/932,341, having been filed in the United States Patent and Trademark Office on Feb. 23, 2011 and now incorporated by reference herein.

### STATEMENT OF GOVERNMENT INTEREST

The invention described herein may be manufactured and used by or for the Government of the United States of America for governmental purposes without the payment of any royalty thereon.

### BACKGROUND OF THE INVENTION

1. Technical Field of the Invention

This invention relates generally to the field of fabrication techniques for the production of electrically conductive structures. More specifically, the present invention relates to the thermoplastic molding of electrical structures which possess desired properties of electrical conductivity, radio frequency (RF) energy reflectivity, and electromagnetic interference (EMI) shielding, while still retaining the very high degree of structural rigidity and dimensional accuracy and stability required for use at microwave and millimeter wave RF frequencies. Applications for the present invention include but are by no means limited to the specific examples described herein, including the production of component parts of stowable antenna structures to be used with lightweight, portable, satellite communications ground terminals.

2. Background and Prior Art

By way of example to demonstrate the necessity for plastic-formed conductive and reflective electronic components, consider the field of satellite communications. Communication by satellite is essential in remote locations of the world where terrestrial communications networks do not exist. Moreover, when moving about remote locations, satellite communications equipment must be mobile. Smaller, lighter satellite communications equipment affords greater mobility. Satellite communications in the higher frequency bands such as X, K and Ku require a minimum transmit and receive directed gain that is much higher than the non-directional gain of handheld satellite transceivers in the L-band. Therefore, to achieve the necessary directional gain, mobile satellite transceivers in the X, K and Ku bands require directional antenna systems generally comprising parabolically shaped reflecting surfaces.

Generally speaking, while electronics have become smaller and more efficient over the years, minimum antenna size remains bounded by the physics of electromagnetic radiation and the need for larger physical antenna size (i.e., aperture) to achieve a higher directed gain.

It is not uncommon for antenna systems to comprise the least transportable component of modern portable satellite transceivers.

Efforts have been made to achieve a higher degree of transportability of satellite communications antenna systems. Early efforts employed umbrella-like unfolding antennas comprising Mylar material stretched over lightweight metallic frameworks. Other efforts incorporated parabolic-shaped recesses into the satellite terminal enclosures themselves. Many others efforts involved assembling sections of flat or semi-flat panels into mosaics to achieve a larger reflecting surface. While some of these designs may indeed increase directed gain at low satellite frequencies such as in the L-band, they provide inherently unacceptable directive gain at X, K and Ku bands. The constraint which prior attempts at portable designs face at higher frequencies is their inability to provide true parabolic reflecting surfaces necessary for narrow, focused (i.e., directed) beamwidths required not only for gain, but also for discriminating among adjacent geostationary satellites position in equatorial orbits.

Antennas made using traditional carbon fiber composite fabrication techniques provide an excellent solution (high accuracy, stability light-weight/portability; and can be molded into complex shapes for antenna segmentation and stowability), but are prohibitively expensive for all but the most demanding applications such as military satellite communications systems.

What the prior art fails to provide and what is needed, therefore, is a means to produce low-cost, light weight, dimensionally stable and rigid, geometrically accurate, electrically conductive and RF reflective structures for exemplary applications including transportable radio frequency antennas.

### OBJECTS AND SUMMARY OF THE INVENTION

The present invention provides a method for producing electrically-conductive plastic resin and carbon fiber composite structures utilizing a thermoplastic injection molding process. These structures possess the properties of very high surface electrical conductivity, radio frequency (RF) reflectivity, and electromagnetic interference shielding, as well as a very high degree of mechanical rigidity and dimensional stability.

It is therefore an object of the present invention to provide a low-cost method for the fabrication of molded structures having an electrically conductive, very rigid carbon fiber shell, using thermoplastic injection molding techniques.

It is a further object of the present invention to provide a method for producing very lightweight, inexpensively-molded, electrically-conductive component parts such as radio frequency antennas, EMI shielded enclosures, and the like, which also possess a very high degree of dimensional stability.

Briefly stated, the present invention achieves these and other objects by providing a low-cost method for thermoplastic resin-based molding of electrical structures which possess desired properties of electrical conductivity, radio frequency (RF) energy reflectivity, and electromagnetic interference (EMI) shielding, while also possessing the structural rigidity and dimensional stability of a traditional resin-fiber composite structure such as what might be produced from an epoxy-woven carbon fiber cloth lay-up or resin-infusion process. While it is understood that a number of techniques exist to produce resin-molded articles with the desired properties of electrical conductivity and RF reflectivity, the present invention discloses unique methods of fabricating such articles also possessing structural properties of traditional epoxy-carbon fiber composite production methods, all using a very low cycle time and low cost injection molding process.

In a fundamental embodiment of the present invention, a method for thermoplastic/fiber composite-based electrically conductive structures, a metalized, thermoplastic pre-impregnated woven fabric layer is adhered or mechanically positioned over each surface of the mold cavity, such that a molten thermoplastic will fill the space between the fabric layers, thus essentially forming a very rigid fiber-reinforced shell around a thermoplastic core. The high heat and injection pressure of the injected plastic forces the fabric shell into conformance with the mold surfaces, while also fusing to it to form a continuous solid structure. When the resin mixture cools, cures, or otherwise is solid, the structure is removed from the mold. Alternatively, it may be necessary to metallize only one of the fabric layers, such as in the case of a parabolic antenna reflector article, where only one side needs to reflect RF energy. In this case, the opposing fabric layer only serves the purpose of providing the required structural precision and rigidity. Variations of the injected thermoplastic composition can be employed to further enhance the desired properties of the final product.

Still according to the above fundamental embodiment of the present invention, the injected thermoplastic resin is chosen such that it has a melt processing temperature (temperature of the melted plastic at the nozzle of the injection molding machine) that is significantly higher than the glass transition temperature (Tg) of the thermoplastic used to pre-impregnate the woven fabric layers, thus providing for integral fusing of the fabric layer to the injected core, resulting in a much stronger, dimensionally accurate part.

An additional embodiment of the invention further discloses the addition of ribbings or corrugations and other modifications to the mold surface to likewise modify the molded part's shell surface to enhance structural strength, rigidity, and dimensional accuracy and stability of the molded part.

Another embodiment of the invention discloses the use of a metallized non-woven (smooth surface) fabric on top of the structural woven fabric layer with both fabrics being pre-impregnated with a thermoplastic resin to form a more reflectively smooth outer surface on the molded part. This embodiment is motivated by the fact that the metallized woven fabric alone would result in a somewhat rough electrically conductive surface due the three-dimensional nature of the fabric weave which could cause problems for antennas at high frequencies (where the dimension of the weave is greater than about 1/10 the radio frequency wavelength).

Still, a further embodiment of the invention discloses the use of a fiber-filled thermoplastic resin as the injection molded plastic raw material. In this embodiment, the raw plastic resin pellets are commercially compounded with chopped fiber comprised of glass, carbon, or other materials so that the fibers are randomly distributed in the melted plastic as it is injected into the mold cavity. The purpose of this fiber fill is to provide overall structural rigidity and strength, as well as to minimize part shrinkage that naturally occurs as the plastic cools and hardens.

The above and other objects, features and advantages of the present invention will become apparent from the following description read in conjunction with the accompanying drawings, in which like reference numerals designate the same elements.

### BRIEF DESCRIPTION OF THE DRAWINGS

FIG. 1 depicts an exemplary segmented parabolic satellite terminal antenna produced by the present invention.

FIG. 2 depicts the relation of a thermoplastic injection mold to the fabric layers in a manner that reliably forces said fabric layers into conformance with the mold surfaces during the injection molding process.

### DETAILED DESCRIPTION OF THE PREFERRED EMBODIMENT

The present invention describes a low-cost thermoplastic injection molding method for producing electrically conductive and reflective articles which also have structural properties similar to like articles fabricated by traditional epoxy/carbon fiber composite techniques.

The present invention fundamentally comprises the steps of over-molding of metalized (or otherwise electrically conductive and radio frequency reflective) thermoplastic pre-impregnated, high strength, continuous woven fiber fabric layers that cover one or more sides of the mold, and injecting molten plastic between the layers under high pressure, so that each is conformed to its corresponding mold surface and fused to the injected plastic core. Because simply inserting the two fabric layers into the mold would result in both being forced to one side by the incoming plastic, the present invention discloses a method to cause the flowing plastic to press each fabric layer against its corresponding mold half, and thus essentially “inflating” the layers to form the outer composite shell with the inner plastic core.

The method conceived by the present invention to solve this problem involves first creating a small opening in the fabric layer that conforms to the injection port or “sprue” side of the mold (i.e., the side from which the molten plastic is injected), and applying some type of high tack adhesive to the edge of the fabric layer opening so that it can be sealed against the circumference of the sprue injection point, thus causing the molten plastic to begin flowing to the inward-facing side of this fabric layer. Once the plastic begins to flow, and the mold cavity begins to fill, the high pressure and rapid flow of the plastic will reliably force this sprue-side fabric layer (i.e., a first fabric layer) against the sprue side of the mold. The flowing plastic will likewise, automatically force the opposing layer of fabric (i.e., a second fabric layer) to the other side of the mold. Thus, the injected plastic essentially inflates the space between the fabric layers, with the formation of a part comprising a rigid resin/fiber composite outer shell around a solid plastic core. The only other consideration in this process is, besides the aforementioned method of sealing the sprue-side fabric layer opening around the injection point, is providing either a mechanical fastener or other tack adhesive means of loosely holding the fabric layers in their correct positions before the injected plastic is molded over them.

A major goal of the present invention is to assure that the fabric layer(s) are completely permeated by the melted resin so that the surface quality of the finished part has essentially the same look and feel that the inner plastic core material would have without the embedded fabric. That is, to provide a means of assuring that the outer fabric shell layer is integral and virtually indistinguishable in outward appearance as the same molded part would have without the fabric layer. As a result, in most applications, the fabric layer (e.g., woven carbon fiber) would be completely conformal to the mold surface, at just a miniscule depth (a few thousandths of an inch or so) below the structure's surface, with no textural evidence of the fiber at the surface of the part.

This outcome is assured by choosing the plastic used for pre-impregnation of the fabric to be a thermoplastic which has a glass transition temperature that is significantly lower than the melt processing temperature of the injection molded (core) plastic. Thus, the very hot injected plastic has time to thoroughly infiltrate and fuse with the cured plastic in the fabric before the entire part hardens. Under the high pressures (1000 to 10000 psi) typically associated with injection molding, the core plastic actually displaces and mixes with the pre-impregnated plastic so there is essentially no distinguishable material composition boundary between the core plastic and the surface of the part. The woven fabric layer(s) is completely conformal to the part surface, and completely integral to the plastic core so as to provide a composite shell of optimal strength and dimensional accuracy, while also providing for surface electrical conductivity and RF reflectivity when the fabric has been metallized prior to pre-impregnation.

Candidate fabrics will generally be fairly thin (around 0.010″ or less) and sufficiently porous to allow pre-impregnation with an appropriate thermoplastic resin material prior to the injection molding step. If it is also desired to provide for surface electrical conductivity and RF energy reflectivity, the fabric layer will have to first be metallized before it is pre-impregnated with thermoplastic. This metallization can be accomplished by several established means such as metal vapor deposition and electroplating. Generally, these processes coat the individual fibers of the fabric with a microscopically thin layer of metal, with the resulting fabric retaining its mechanical flexibility and porosity. Both of these processes allow for the deposition of a number of useful metal types as nickel, copper, and aluminum. The base fabric could be any number of materials appropriate for any number of desired end-use applications. However, current embodiments of the invention anticipate continuous fiber woven fabrics comprised of one or more of high strength materials such as carbon/graphite, glass, and Kevlar, with a fabric layer thickness between about 0.003″ to about 0.010″. Applications providing for an increased melt processing temperature of the core thermoplastic and/or where there is a larger volume to surface area ratio of the mold cavity, with a resulting greater total heat capacity of the molten core plastic, may allow for the use of thicker fabric layers, possibly as high as 0.020″ to 0.030″.

The following, taken in conjunction with the drawings will provide a detailed description of a specific implementation of the invention, and the overall scope of the invention in general.

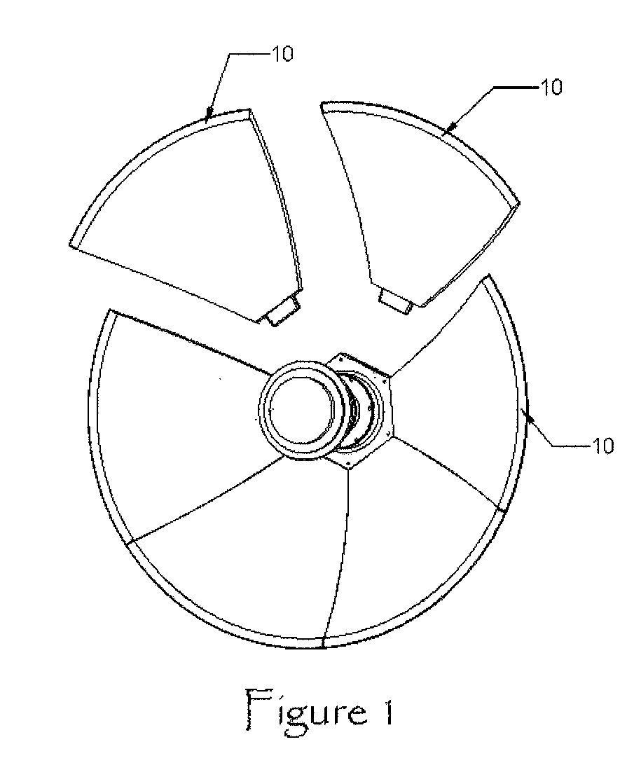

Referring to FIG. 1, an application of the present invention of immediate interest is the production of an 18″ diameter parabolic satellite communications antenna reflector comprised of six (6) identical segments 10 that plug into a center hub/feed assembly to form the complete reflector. Each segment (“petal”) 10 is individually molded via the above process to have an RF-reflective surface sufficient to give the antenna a high efficiency rating (close to that for the same geometry antenna alternatively made from solid aluminum).

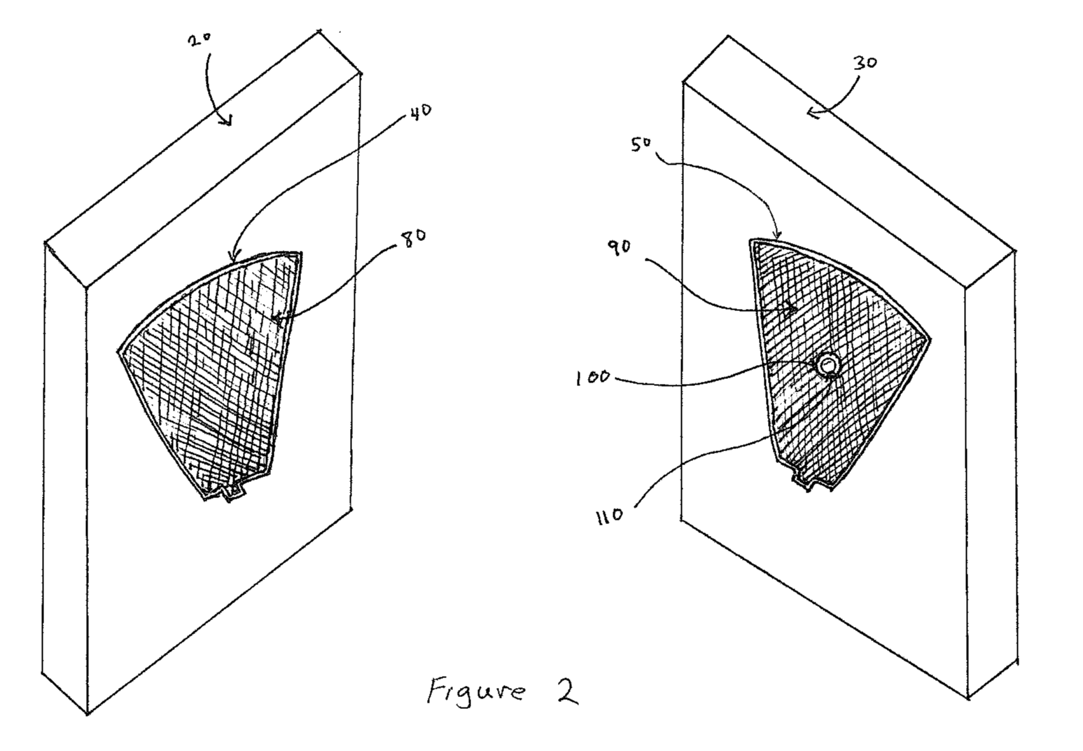

Referring to FIG. 2, production of the reflector petals per the methods of the invention is as follows. Starting with the fabric layers, a first 40 and a second 50 identically shaped piece of high strength continuous fiber woven carbon/graphite cloth, each having a thickness of about 0.004″ (prior to pre-impregnation with thermoplastic) are cut to the approximate shape of the footprint of the mold cavity halves 20, 30. The first fabric piece 80 conforms to the reflective surface of the structure to be produced (i.e., the concave side of the RF antenna reflector segment) and has been metallized in a prior step by any one of several known means, such as vapor deposition or electro-plating with a thin layer of metal (relative to the diameter of the individual fibers comprising the cloth) deposited over the surface of each fiber, and such that the cloth still retains its basic porosity, so that it can be thoroughly permeated by the pre-impregnating plastic. The second and opposing fabric piece 90 is only needed for structural integrity and dimensional accuracy, and thus does not ordinarily require the metallization step.

The two fabric pieces 80, 90 must now first be pre-impregnated with an appropriate thermoplastic before the injection molding step. This pre-impregnation plastic material is chosen to have a glass transition temperature that is substantially lower than the melt processing temperature of the core injection thermoplastic to allow for complete fusion of the fabric and the core layer of the final part. The pre-impregnation step can be accomplished via a number of traditional means such hot melting or hot pressing of the fabric and plastic layers. However, a preferred means for the purpose of the present invention is to first form an organic solution of the plastic and spray or paint it onto the fabric layer. This technique allows for more complete penetration and coverage between the fibers, as well as better control over thickness of the plastic on either side of the fabric surface. With this process, the solvent evaporates via air drying, with subsequent re-polymerization and re-hardening of the thermoplastic. At this point the first and second fabric pieces are now ready for the injection molding step.

The present invention is optimized through the use of the group of thermoplastics, mainly those of the styrene composition type, particularly, polystyrene and ABS (acrylonitrile butadiene styrene) which are easily soluble in an organic solvent. These plastics are the most desirable for the purpose of the invention due to the fact they have a relatively low glass transition temperature (around 210-220 degrees F.), and also appear to be chemically and mechanically very compatible with most of the high strength/rigidity, high working temperature plastics that would be desirable as the core plastic to be used in currently anticipated applications of the invention; such as the antenna reflector segments 10 (see FIG. 1). Examples of these core thermoplastics include polycarbonate (Lexan), heat-resistant nylon, and polyetherimide. These have melt processing temperatures of around 450-490 degrees F., 450-500 degrees F., and 600-800 degrees F., respectively. Thus, polystyrene or ABS plastic is dissolved into an appropriate volatile (readily evaporating) solvent such as methylethylkeytone (MEK) or acetone to form a solution with a viscosity of ordinary paint, and then sprayed (or brushed) onto one or both sides of the first and second fabric pieces until they are sufficiently permeated and covered. These are allowed to thoroughly dry before being used in the next manufacturing step.

At this point the first 80 and second 90 fabric pieces are placed into each corresponding halves of the mold 20, 30 and held in place over each corresponding mold surface using a tack adhesive, double-sided tape, mechanical clamp, or some other temporary means of keeping the fabric properly positioned during the injection molding step, and which easily disconnects from the fabric during the molding process and/or as the part is ejected from the mold after hardening. Note that, in a preliminary step, the second fabric piece that is on the injection port 110 or “sprue” side of the mold (the side into which the melted core plastic is injected) is first cut or punched to form a through-hole 100 in the fabric 90 that is at least as large as the diameter of the plastic injection port 110 in the mold half 30 at the location on its surface that will be in alignment with this plastic injection point 110. Note that the plastic injection point 110 could generically be any of a sprue bushing center opening, runner, or other entry point for the injected plastic based on the design of the particular mold hardware. In the case of the present invention, however, the plastic is being injected directly into the mold cavity from the sprue bushing at the injection point. In order for the molding process to function correctly, the perimeter of this through-hole 100 must be well-sealed around the plastic injection port 110 so that the injected core plastic begins to flow towards the inside surface of the second 90 fabric piece (the surface facing away from the corresponding inside surface of mold half), thus forcing it into conformance with the inside surface of the mold half 50. The injected plastic will likewise force the opposing fabric piece 80 into conformance with the inside surface 40 of the opposing mold cavity. Thus, the injected plastic essentially inflates the space between the first 80 and second 90 fabric layers, and under the very high heat and pressure of this process, completely infiltrates and mixes with the pre-impregnating plastic contained therein.

The first 80 and second 90 fabric layers become integrally fused with the injected plastic core, and form a very strong, dimensionally stable composite shell which is in near perfect conformance with all of the part surfaces. A material combination to be used in the preferred embodiment of the present invention is ABS as the pre-impregnating plastic and Ultem as the injected core plastic. Ultem is a fairly common, and relatively inexpensive polyetherimide plastic that has a very high melt processing temperature (600-800 degrees F.). It is also very strong, dimensionally stable, and has a high operational use temperature of about 300 degrees F. In this example, the surface formed by the first fabric layer also has the desired RF reflective properties for a microwave antenna reflector.

It is further understood that the electrically conductive surface of the first 80 fabric layer is rough in texture, due to the somewhat three-dimensional nature of a woven fabric. Since surface roughness can cause loss of antenna efficiency as frequency of operation is increased, it is desirable to find a way to maintain the essential features of the invention, while providing for smoother electrical surface. This can be achieved with the additional step of incorporating a relatively thin (on the order of about 002″ to 0.004″ thickness), metallized non-woven fabric layer on top of the woven first 80 fabric layer, which now is not required to be itself metallized. These are either pre-impregnated separately, or preferably together to form a single laminated layer, which essentially replaces the first 80 fabric layer in the present invention. This achieves the desired result because the non-woven fabric has a very flat surface, like that of a sheet of paper, as opposed to that created by the interweaving of relatively large continuous fiber bundles used to construct woven cloth. Thus, the non-woven, metallized fabric side of the new first 80 fabric layer is positioned so that it is facing the inside surface of the mold half, so that it becomes the improved RF-reflective surface of the finished part.

Another variation of the present invention is to metallize only selected areas of the first 80 fabric layer so as to form specific conductive contours that could be made to serve as specialized antenna elements, or for other possible applications. The former could be designed to generate specific RF antenna beam patterns, for example. This specifically metalized first 80 fabric layer could likewise be pre-impregnated and injection-molded into a desired form such as a conformal planar antenna.

Referring back to the embodiment of the present invention where a second 90 fabric layer is included solely for the purpose of completing the structural composite shell around the whole part, it is noted that a ribbed contour machined into the mold surface can be employed to provide further structural strength and rigidity to the final part. Thus, the second 90 fabric layer conforms to the rib surface during the injection molding step, and results in part with a resulting corrugated composite shell of such design that adds to the structural rigidity and dimensional stability of the final part. Such structural reinforcement features could be readily added in any given application where they did not interfere with the essential functional operation of the part. Therefore, such reinforcements might not be added to the reflective surface subject antenna reflector petal, for example.

Another consideration for further improving the desired structural features of the present invention includes the use of a fiber-reinforced injected molded plastic to form the core of the parts in the above examples. The percentage of fiber fill can range from zero to as high as can be used in the molding set-up; the limit typically being the increase in viscosity that results from the increased percentage of fiber in the plastic, and thus its ability to flow into and fill the mold. The purpose of the fiber is to provide further overall structural rigidity and strength, as well as to minimize part shrinkage that naturally occurs as the plastic cools and hardens. The combination of the fiber-filled plastic core and the woven fiber composite shell makes for an extremely accurate and durable part that is mechanically very similar to a traditionally fabricated epoxy/carbon fiber composite part.

A final consideration could be the addition of a standard foaming agent to the injected core plastic, whether or not it is fiber reinforced, to create small bubbles within the material for the purpose of overall part weight reduction and to reduce part shrinkage that could contribute to dimensional inaccuracies in the final part.

The present invention thus provides for the inexpensive, rapid production of complex composite parts with tailored electrical and RF reflective properties, which can be made to possess mechanical strength and dimensional accuracy and stability very close to that of a similar part made using traditional carbon fiber/epoxy composite lay-up or infusion methods. Due to the nature of the materials used, the method of the invention can also produce parts which are lighter in weight than the said traditional methods.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method for producing thermoplastic and fiber composite-based electrically conductive structures, comprising the steps of:
affixing a first pre-impregnated fabric layer into a first surface of an injection mold cavity having opposing first and second cavity surfaces;
affixing a second pre-impregnated fabric layer into a second surface of an injection mold cavity;
excising a portion of said second pre-impregnated fabric layer at a location coincident with an injection port located on said second surface of said injection mold so as to create a through-hole, wherein said through-hole aligns with said injection port;
affixing the perimeter of said through-hole to said second surface of said injection mold cavity so as to direct passage of injected thermoplastic from said injection port, through said through-hole, and into said injection mold cavity; and
injecting a core thermoplastic into said injection port so as to conform said first and said second pre-impregnated fabric layers to said injection mold cavity surfaces; and
filling said injection mold cavity with said thermoplastic.

2. The method of claim 1, further comprising the step of pre-impregnating said pre-impregnated fabric layers with a pre-impregnation thermoplastic wherein said glass transition temperature of said pre-impregnation thermoplastic is lower than said melt processing temperature of said core thermoplastic injected into said mold cavity.

3. The method of claim 2, further comprising the step of metallizing at least one of said pre-impregnated fabric layers prior to said step of pre-impregnation.

4. The method of claim 3, further comprising the step of metallization by performing any one of the following: metal vapor deposition, chemical vapor deposition, or electroplating.

5. The method of claim 4, further comprising said step of performing metallization prior to the step of pre-impregnating said pre-impregnated fabric layers.

6. The method of claim 5, further comprising the step of combining a non-woven fabric layer prior to pre-impregnating said at least one of said metallized pre-impregnated fabric layers so as to form a metallized lamination.

7. The method of claim 6, wherein said first and said second pre-impregnated fabric layers comprise woven fabric selected from the group consisting of carbon/graphite, glass, and Kevlar.

8. The method of claim 7, wherein said woven fabric is substantially between 0.002 inches and 0.030 inches in thickness.

9. The method of claim 8, wherein said pre-impregnation thermoplastic is a styrene-based thermoplastic.

10. The method of claim 9, wherein said pre-impregnation thermoplastic is selected from the group consisting of polystyrene and ABS.

11. The method of claim 10, wherein said core thermoplastic is an engineering thermoplastic selected from the group consisting of polycarbonate, nylon, and polyetherimide.

12. The method of claim 11, wherein said step of pre-impregnation further comprises the step of depositing a liquid solution of said pre-impregnation thermoplastic and allowing it to dry and harden.

13. The method of claim 12, wherein said step of depositing further comprises spraying or painting.

14. The method of claim 13, wherein said step of injecting a core thermoplastic into said injection port further comprises injecting a core thermoplastic which is fiber reinforced.

15. The method of claim 14, wherein said step of injecting a core thermoplastic into said injection port further comprises injecting a core thermoplastic which is infused with expanding agents.

16. The method of claim 15, wherein the glass transition temperature of said pre-impregnation thermoplastic is at least 200 degrees F. less than the melt processing temperature of said core thermoplastic.

17. The method of claim 16, wherein said liquid solution of said pre-impregnation thermoplastic is created by the further step of dissolving said pre-impregnation thermoplastic in an organic solvent.

18. The method of claim 17, wherein said organic solvent is selected from the group consisting of acetone and methyl ethyl ketone (MEK).

19. The method of claim 18, further comprising the step of machining at least one surface of said mold cavity so as to produce structural reinforcement features in said conductive structure.
